(19) United States
(12) Patent Application Publication
(10) Pub. No.: US 2009/0016751 A1
(43) Pub. Date: Jan. 15, 2009

(54) METHOD AND APPARATUS FOR CLEANING ATTACHMENT ON TRANSFER ROLLER IN AN IMAGE FORMING APPARATUS

(76) Inventors: Yen-Liang Meng, Taipei City (TW); Cheng-Chin Chen, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/775,855

(22) Filed: Jul. 10, 2007

(51) Int. Cl. G03G 15/02; G03G 15/16

(52) U.S. Cl. 399/50; 399/66; 399/101

(57) ABSTRACT

An image forming apparatus includes a photoconductor, a transfer roller, and a power supply for providing a voltage signal for the transfer roller to transfer surface attachments on the transfer roller to the photoconductor. Moreover, before providing the voltage signal for the transfer roller, a surface voltage level of the photoconductor can be adjusted according to the voltage signal in order to ensure that the surface voltage level of the photo conductor can be kept in a safe charging range. Therefore, the transferring efficiency of the transfer roller is ensured and damage to the photo conductor is prevented.

### BACKGROUND OF THE INVENTION

1. Field of the Invention

The present invention relates to an image forming apparatus, and more particularly, to an image forming apparatus able to clean surface attachments on a transfer roller and a method thereof.

2. Description of the Prior Art

The image forming process of an electrophotographic image forming device includes charging, exposing, developing, transferring, fusing, cleaning and erasing. During the developing, toner is attached on a photoconductor to form a toner image, and then in the transferring step, the toner image developed on the photoconductor is transferred onto paper. In the transferring step, the paper is delivered by utilizing a transfer roller. Because the paper will contact with the transfer roller during transferring, fibers and impurities on the paper will adhere to the surface of the transfer roller. Moreover, when an abnormal printing situation occurs such as a paper jam occurs, the surface of the transfer roller will be dirtied by toner. These situations all result in an increase of surface impedance of the transfer roller, which decreases the transferring efficiency and causes problems such as pollutions on a backside of the paper. Therefore, the transfer roller must be cleaned to maintain the printing quality of the printing device.

A conventional method of cleaning the transfer roller is to add an extra brush by the side of the transfer roller, and utilize the brush to clean the surface attachments on the transfer roller. Since the toner on the transfer roller is usually charged, the brush is provided with a voltage in some embodiments to enhance the cleaning effect. Hence, the present invention provides a method different from the conventional method for cleaning the transfer roller, and provides an image forming apparatus applying the new method.

### SUMMARY OF THE INVENTION

One objective of the present invention is to provide a method of transferring surface attachments on a transfer roller of an image forming apparatus and an image forming apparatus applying the method.

According to an embodiment of the present invention, a method of transferring surface attachments on a transfer roller of an image forming apparatus is disclosed. The method comprises making the transfer roller contact with a photoconductor, and providing a voltage signal on the transfer roller to transfer the surface attachments on the transfer roller to the photoconductor.

According to another embodiment of the present invention, a method of transferring surface attachments on a transfer roller of an image forming apparatus is disclosed. The method comprises providing a voltage signal switching between a negative voltage level and a positive voltage level, and providing the voltage signal on the transfer roller to transfer the surface attachments on the transfer roller to a photoconductor.

According to another embodiment of the present invention, an image forming apparatus is disclosed. The image forming apparatus comprises a photoconductor, a transfer roller, and a power supply connected to the transfer roller, for providing a voltage signal on the transfer roller to transfer the surface attachments on the transfer roller to the photoconductor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an image forming apparatus according to an embodiment of the present invention.

FIG. 2 is a waveform diagram of a current provided by a power supply shown in FIG. 1.

FIG. 3 is a diagram showing impedance variation of a transfer roller shown in FIG. 1 after a transferring process of the present invention is performed.

FIG. 4 is a diagram showing measuring locations adopted in FIG. 3.

### DETAILED DESCRIPTION

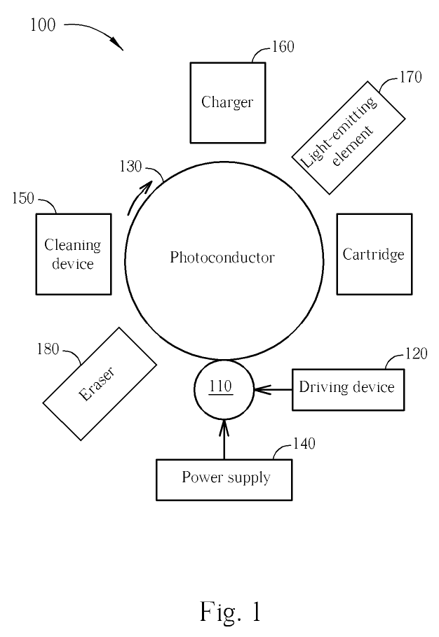

FIG. 1 is a diagram of an image forming apparatus 100 according to an embodiment of the present invention. When the image forming apparatus 100 is in a specific operating state of transferring surface attachments on a transfer roller 110 (that is, the state of cleaning the surface attachments on the transfer roller 110), a driving device 120 first makes the transfer roller 110 to contact with a photoconductor 130. The photoconductor 130 can be a photoconductor drum or an organic photoconductor belt. Next, a power supply 140 connected to the transfer roller 110 provides a voltage signal on the transfer roller 110. A function of the voltage signal is to cause the surface voltage absolute value of the transfer roller 110 to be much lower than the surface voltage absolute value of the photoconductor 130, thereby electrically forcing the surface attachments on the transfer roller 110 to jump onto the photoconductor 130. As the photoconductor 130 rotates, the attachments transferred onto the photoconductor 130 can be moved by a cleaning device 150 (e.g. a cleaning blade) utilized to clean residual toner on the photoconductor 130 in the image forming apparatus 100. Therefore, the objective of cleaning the transfer roller 120 is accomplished.

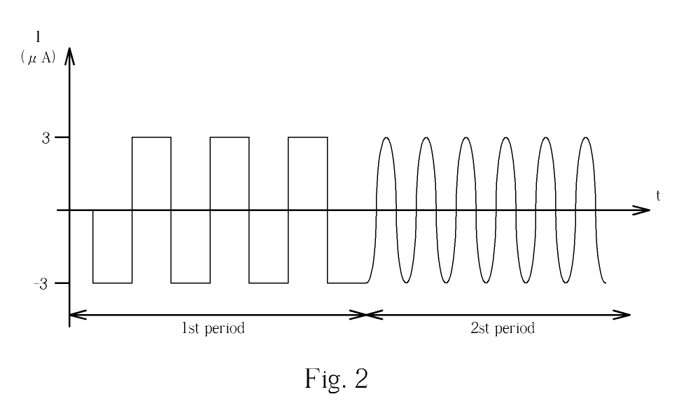

In one embodiment, the current polarity of the power supply switches between positive and negative in order to cause the voltage signal to switch between a negative voltage level and a positive voltage level, as shown in FIG. 2. Note that the switching frequency can be changed. For example, during a first period, the switching frequency of the voltage signal provided on the transfer roller 110 switching from the negative voltage level to the positive voltage level or switching from the positive voltage level to the negative voltage level is equal to the rotating frequency of the transfer roller 110. That is, the power supply 140 changes the polarity of the output voltage signal once each time the transfer roller 110 has rotated a cycle. During a second period, the switching frequency of the voltage signal is three times the rotating frequency of the transfer roller 110. Therefore, the polarity of the voltage signal is switched three times during one rotation cycle of the transfer roller 110. Switching the polarity of the voltage signal allows the surface attachments on the transfer roller 100 to be subjected to reciprocal actions of electrostatic attract and repel forces, and causes them to jump onto the photoconductor 130. It acts similar to physically tapping the transfer roller 100, wherein the tapping speed corresponds to the varied switching frequency. In this way, the surface attachments of the transfer roller 110 can be removed more completely.

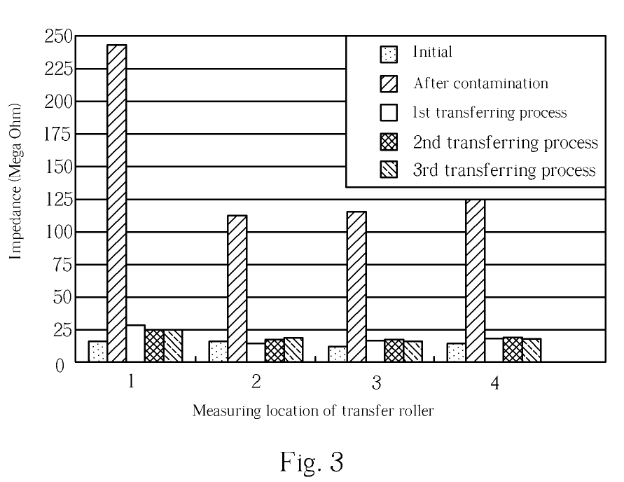

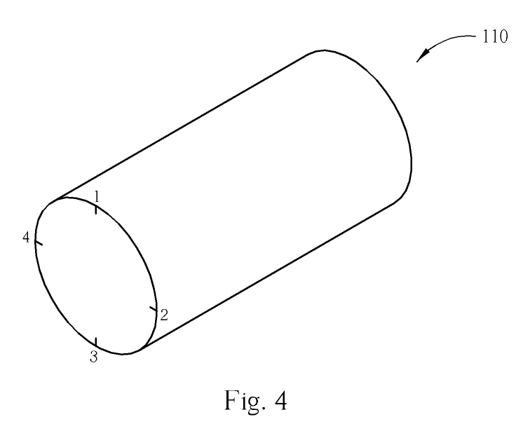

Please refer to FIG. 3, which is a diagram showing an impedance variation of the transfer roller 110 during the above transferring process. The measuring locations of the transfer roller 110 indicated by the horizontal axis of FIG. 3 are shown in FIG. 4. Four locations of the transfer roller 110 are selected equally positioned while performing the impedance measurement. As can be seen from FIG. 3, the impedance of the transfer roller 110 varies significantly after one transferring process. The resulting impedance is almost the same as the initial impedance before the contamination occurred. In this way, the present invention efficiently moves the surface attachments on the transfer roller 110 without extra cleaning elements such as a brush. Additionally, the present invention can also ensure the transfer efficiency of the transfer roller 110 and prevent pollutions on the backside of the paper.

In the above embodiment, when the transfer roller 110 is in contact with the photoconductor 130, the voltage/current provided on the transfer roller 110 will induce an influence on the surface voltage level of the photoconductor 130, causing damages to the photoconductor 130, and shortening usage life and changing physical properties of the photoconductor 130. This is because the photoconductor 130 has a safe charging range usually being 0˜−1000V but depending on the thickness of transport layer in dielectric layer of the photoconductor 130. When a voltage higher than 0V or lower than −1000V is applied on the surface of the photoconductor 130, the voltage will result in a dielectric breakdown through pin-holes on the surface of the photoconductor 130. This will damage the photoconductor 130 or influence the physical properties (e.g. photo sensitization and charging characteristic) of the photoconductor 130. Note that the surface voltage level variation of the photoconductor 130 caused by the voltage signal provided on the transfer roller 110 may be up to about ±400V. Therefore, if the surface voltage level of the photoconductor 130 is 0V (the photoconductor 130 is not charged in advance) or is charged to a working voltage level (such as −800V), the surface voltage level will exceed the safe charging range during the transfer process (note that the working voltage level means a desired voltage level of the photoconductor when developing an image). In order to protect the photoconductor 130, the surface voltage level of the photoconductor 130 can be adjusted according to the voltage signal before the voltage signal is applied. The adjustment is to make the surface voltage level fall in a specific (definable) voltage range, wherein the specific voltage range is determined based on a condition that the surface voltage level of the photoconductor 130 will not go beyond the safe charging range even if it is influenced by the voltage signal. The usage life of the photoconductor 130 is therefore under protection and extended.

In one embodiment, the center of the specific voltage range is a half of the working voltage (−800V) of the photoconductor 130. For example, the specific voltage range is −400±200V. When adjusting the surface voltage level of the photoconductor 130, a charger 160 in the image forming apparatus 100 can be utilized to control the surface voltage level of the photoconductor 130 within the specific voltage range. For example, adjusting the working voltage of the charger 160 to −400V, and then charging the surface of the photoconductor 130 by the charger 160. In another embodiment, the surface voltage level of the photoconductor 130 can first be charged to a specific voltage level (such as the working voltage level) by the charger 160, and then be adjusted to be within the specific voltage range by a light-emitting element 170 (i.e. an LED) or an eraser 180 in the printing device 100. Since the charger 160, the light-emitting element 170, and the eraser 180 are available elements for changing the surface voltage level of the photoconductor 130 in a common image forming apparatus, a person skilled in the art shall easily appreciate the operations and design of those elements after reading the above disclosure. Detailed description is therefore omitted for brevity.

Please note that, in the above embodiments, the transferring process on the surface attachments of the transfer roller can achieve the goal of cleaning the transfer roller. However, the present invention is not limited to only being utilized to clean the transfer roller. That is, the transferring process disclosed above can be implemented in other purposes. Printing devices applying the above transferring process should all fall within the scope of the present invention.

Those skilled in the art will readily observe that numerous modifications and alterations of the device and method may be made while retaining the teachings of the invention.

What is claimed is:

1. A method for transferring surface attachments on a transfer roller of an image forming apparatus, comprising:
making the transfer roller contact with a photoconductor; and
providing a voltage signal on the transfer roller to cause the surface attachments to be transferred from the transfer roller to the photoconductor.

2. The method of claim 1, further comprising:
adjusting a surface voltage level of the photoconductor to be within a specific voltage range according to the voltage signal.

3. The method of claim 2, wherein the step of adjusting the surface voltage level of the photoconductor to be within the specific voltage range further comprises:
utilizing a charger of the image forming apparatus to control the surface voltage level of the photoconductor to be within the specific voltage range.

4. The method of claim 2, wherein the step of adjusting the surface voltage level of the photoconductor to be within the specific voltage range further comprises:
utilizing a charger of the image forming apparatus to control the surface voltage level of the photoconductor to be a working voltage level; and
utilizing a light-emitting element or an eraser of the image forming apparatus to adjust the surface voltage level of the photoconductor to be within the specific voltage range.

5. The method of claim 2, wherein the specific voltage range is centered at half of a working voltage level of the photoconductor.

6. The method of claim 1, wherein the voltage signal switches between a negative voltage level and a positive voltage level.

7. The method of claim 6, wherein a switching frequency of the voltage signal switching between the negative voltage level and the positive voltage level is not fixed.

8. A method for cleaning surface attachments on a transfer roller of an image forming apparatus, comprising:
providing a voltage signal switching between a negative voltage level and a positive voltage level; and
providing the voltage signal on the transfer roller to cause the surface attachments to be transferred from the transfer roller to a photoconductor.

9. The method of claim 8, further comprising:
adjusting a surface voltage level of the photoconductor to be within a specific voltage range according to the voltage signal.

10. The method of claim 8, further comprising:
utilizing a charger of the image forming apparatus to control the surface voltage level of the photoconductor to be within the specific voltage range.

11. The method of claim 8, further comprising:
utilizing a charger of the image forming apparatus to control the surface voltage level of the photoconductor to be a working voltage level; and
utilizing a light-emitting element or an eraser of the image forming apparatus to adjust the surface voltage level of the photoconductor to be within the specific voltage range.

12. The method of claim 9, wherein the specific voltage range is centered at half of a working voltage level of the photoconductor.

13. The method of claim 8, wherein a switching frequency of the voltage signal switching between the negative voltage level and the positive voltage level is not fixed.

14. The method of claim 8, further comprising:
cleaning the surface attachments on the photoconductor by a cleaning blade.

15. An image forming apparatus, comprising:
a photoconductor;
a transfer roller; and
a power supply, coupled to the transfer roller, for providing a voltage signal on the transfer roller to cause surface attachments on the transfer roller to be transferred from the transfer roller to the photoconductor.

16. The printing device of claim 15, further comprising a driving device for making the transfer roller contact with the photoconductor.

17. The printing device of claim 15, further comprising a voltage adjusting module, for adjusting a surface voltage level of the photoconductor to be within a specific voltage range according to the voltage signal.

18. The printing device of claim 17, wherein the voltage adjusting module comprises:
a charger, for controlling the surface voltage level of the photoconductor to be within the specific voltage range.

19. The printing device of claim 17, wherein the voltage adjusting module comprises:
a charger, for controlling the surface voltage level of the photoconductor to be a working voltage level; and
a light-emitting element or an eraser, for adjusting the surface voltage level of the photoconductor to be within the specific voltage range.

20. The printing device of claim 15, wherein the specific voltage range is centered at half of a working voltage level of the photoconductor.
